(19) United States
(12) Patent Application Publication
(10) Pub. No.: US 2024/0046256 A1
(43) Pub. Date: Feb. 8, 2024

(54) INFORMATION PROCESSING METHOD, INFORMATION PROCESSING DEVICE, AND RECORDING MEDIUM

(71) Applicant: Panasonic Intellectual Property Corporation of America, Torrance, CA (US)

(72) Inventors: Ayaka NAKASAKA, Osaka (JP); Junji MICHIYAMA, Fukuoka (JP)

(21) Appl. No.: 18/381,764

(22) Filed: Oct. 19, 2023

Related U.S. Application Data
(63) Continuation of application No. PCT/JP2022/015970, filed on Mar. 30, 2022.
(60) Provisional application No. 63/178,804, filed on Apr. 23, 2021.

(51) Int. Cl. G06Q 20/38; H04L 9/00

(52) U.S. Cl. CPC G06Q 20/382; G06Q 20/389; H04L 9/50

(57) ABSTRACT

An information processing method that, in a system including a plurality of information processing devices each holding a blockchain, is executed by one information processing device out of the plurality of information processing devices, includes: generating a first block including one or more items of transaction data, and connecting the first block to the blockchain; generating transaction data indicating payment of a reward for generating the first block, when at least T blocks are connected downstream of the first block in the blockchain where T is an integer greater than or equal to 1; and generating a second block including the transaction data generated, and connecting the second block to the blockchain.

### CROSS REFERENCE TO RELATED APPLICATIONS

This is a continuation application of PCT International Application No. PCT/JP2022/015970 filed on Mar. 30, 2022, designating the United States of America, which is based on and claims priority of U.S. Provisional Patent Application No. 63/178,804 filed on Apr. 23, 2021. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

In blockchain technology that realizes a distributed ledger, when chain branching occurs, subsequently a longer chain is adopted and the chains other than the chain are discarded (see Non Patent Literature (NPL) 1).

### CITATION LIST

### Non Patent Literature

NPL 1: Satoshi Nakamoto, “Bitcoin: A Peer-to-Peer Electronic Cash System”, [searched on Mar. 1, 2022], Internet <URL: https://bitcoin.org/bitcoin.pdf>.

### SUMMARY

### Technical Problem

When employing blockchain technology in which chains are discarded, the technology can be improved upon by reducing power consumption in processing leading thereto.

The present disclosure therefore provides an information processing method that contributes to reduction of power consumption required for processing related to generation of transaction data or blocks in a blockchain.

### Solution to Problem

An information processing method according to an aspect of the present disclosure is an information processing method that, in a system including a plurality of information processing devices each holding a blockchain, is executed by one information processing device out of the plurality of information processing devices, the information processing method including: generating a first block including one or more items of transaction data, and connecting the first block to the blockchain; generating transaction data indicating payment of a reward for generating the first block, when at least T blocks are connected downstream of the first block in the blockchain where T is an integer greater than or equal to 1; and generating a second block including the transaction data generated, and connecting the second block to the blockchain.

These general and specific aspects may be implemented using a system, a device, an integrated circuit, a computer program, or a computer-readable recording medium such as CD-ROM, or any combination of a system, a device, an integrated circuit, a computer program, and a recording medium.

### Advantageous Effects

An information processing method according to the present disclosure can contribute to reduction of power consumption required for processing related to generation of transaction data or blocks in a blockchain.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating the structure of a distributed ledger system in an embodiment.

FIG. 2 is an explanatory diagram illustrating functions of a terminal in the embodiment.

FIG. 3 is a flowchart illustrating processes by the terminal in the embodiment.

FIG. 4 is a first sequence diagram illustrating processes by the distributed ledger system in the embodiment.

FIG. 5 is a second sequence diagram illustrating processes by the distributed ledger system in the embodiment.

FIG. 6 is an explanatory diagram illustrating reward payment transaction data included in a blockchain generated by the terminal in the embodiment.

FIG. 7 is an explanatory diagram illustrating functions of a terminal in Variation 1 of the embodiment.

FIG. 8 is a flowchart illustrating processes by the terminal in Variation 1 of the embodiment.

FIG. 9 is a flowchart illustrating processes by a terminal in Variation 2 of the embodiment.

FIG. 10 is an explanatory diagram illustrating the data structure of a blockchain.

FIG. 11 is an explanatory diagram illustrating the data structure of transaction data.

### DESCRIPTION OF EMBODIMENT

### Underlying Knowledge Forming Basis of the Present Disclosure

In relation to the blockchain technology described in the Background section, the inventors have found the following problem.

In the case where chain branching occurs and a chain is discarded in the blockchain technology, processing performed to generate the blocks included in the discarded chain or to generate the transaction data included in the blocks may end up being wasted. In such a case, there is room for reduction of power consumed in the processing.

The processing may include, for example, a process of obtaining and holding one or more items of transaction data to be stored in a block, a process of generating the block from the one or more items of transaction data, and a process of consensus formation regarding the generated block (including consensus algorithm execution process).

Chain branching and discarding occur incidentally, or occur due to an attack intended to cause chain branching and discarding.

The present disclosure provides an information processing method that contributes to reduction of power consumption required for processing related to generation of transaction data or blocks in a blockchain.

An information processing method according to an aspect of the present disclosure is an information processing method that, in a system including a plurality of information processing devices each holding a blockchain, is executed by one information processing device out of the plurality of information processing devices, the information processing method including: generating a first block including one or more items of transaction data, and connecting the first block to the blockchain; generating transaction data indicating payment of a reward for generating the first block, when at least T blocks are connected downstream of the first block in the blockchain where T is an integer greater than or equal to 1; and generating a second block including the transaction data generated, and connecting the second block to the blockchain.

According to this aspect, the information processing device includes, in the second block connected downstream of the first block, the transaction data (also referred to as reward payment transaction data) indicating payment of a reward for generating the first block. This may make it possible to prevent generation of reward payment transaction data for the first block in the case where the first block is discarded after the generation of the first block. In such a case, power consumption required for processing related to the generation of the reward payment transaction data can be reduced. Thus, the information processing method according to the present disclosure can contribute to reduction of power consumption required for processing related to generation of transaction data or blocks in a blockchain.

For example, the generating of the transaction data may include: determining whether a reward condition for paying the reward to the one information processing device is satisfied; and generating the transaction data when the reward condition is determined to be satisfied.

According to this aspect, the information processing device performs determination using the reward condition, and therefore can easily determine whether to generate reward payment transaction data for the first block. Thus, the information processing method according to the present disclosure can more easily contribute to reduction of power consumption required for processing related to generation of transaction data or blocks in a blockchain.

For example, the information processing method may include: generating reward request data requesting the payment of the reward, when the first block is connected to the blockchain, the determining may be performed in response to the reward request data being generated, and the reward condition may include a condition that both of the following are satisfied: (a) a first condition that a second value is greater than a first value by at least T, where the first value is a block height of the blockchain at a time of generating the first block, and the second value is a block height of the blockchain currently held in the one information processing device; and (b) a second condition that a generator of the first block and a generator of the reward request data match.

According to this aspect, the information processing device more easily determines whether the reward condition is satisfied, using the condition regarding the block height of the blockchain and the condition regarding matching between the generator of the block and the generator of the reward request data. Thus, the information processing method according to the present disclosure can more easily contribute to reduction of power consumption required for processing related to generation of transaction data or blocks in a blockchain.

For example, the information processing method may further include: determining whether the second condition is satisfied, before the generating of the reward request data; and prohibiting the generating of the reward request data, when the second condition is determined to be not satisfied.

According to this aspect, the information processing device determines the condition regarding matching between the generator of the block and the generator of the reward request data before the reward request data is generated. It is therefore possible to avoid the generation of the reward request data in the case where the generator of the block and the generator of the reward request data do not match. In such a case, power consumption required for processing related to the generation of the reward request data can be further reduced. Thus, the information processing method according to the present disclosure can contribute to further reduction of power consumption required for processing related to generation of transaction data or blocks in a blockchain.

For example, the first block may not include the transaction data indicating the payment of the reward for generating the first block.

According to this aspect, the information processing device does not include, in the first block, the transaction data (also referred to as reward payment transaction data) indicating payment of a reward for generating the first block. This may make it possible to prevent generation of reward payment transaction data for the first block in the case where the first block is discarded after the generation of the first block. Thus, the information processing method according to the present disclosure can contribute to reduction of power consumption required for processing related to generation of transaction data or blocks in a blockchain.

For example, T may be smaller when the blockchain is a private chain than when the blockchain is a public chain.

According to this aspect, the information processing device uses a relatively small value as T in the case where the blockchain is a private chain. This has the effect of speeding the payment of the reward by speeding the generation of the reward payment transaction data. Meanwhile, the information processing device uses a relatively large value as T in the case where the blockchain is a public chain. This has the effect of further reducing processing and power that will end up being wasted by slowing the generation of the reward payment transaction data. Hence, the information processing device can adjust the effect of speeding reward payment and the effect of further reducing power depending on whether the blockchain is a private chain or a public chain. Thus, the information processing method according to the present disclosure can contribute to reduction of power consumption required for processing related to generation of transaction data or blocks in a blockchain while speeding payment of reward for block generation.

For example, the determining of whether the reward condition is satisfied may be executed by a smart contract, and the reward request data may be transaction data including instruction information instructing to execute the smart contract.

According to this aspect, the information processing device executes the process of determining whether the reward condition is satisfied by the smart contract. The process is therefore appropriately and automatically executed without tampering upon the generation of the transaction data as the reward request data. Thus, the information processing method according to the present disclosure can more appropriately contribute to reduction of power consumption required for processing related to generation of transaction data or blocks in a blockchain.

For example, the payment of the reward may include payment of a network token in the blockchain or payment of a utility token in the blockchain.

According to this aspect, the information processing device uses payment of network tokens or utility tokens in the blockchain to enable easier payment of the reward for generating the first block, with it being possible to reduce power consumption. Thus, the information processing method according to the present disclosure can more easily contribute to reduction of power consumption required for processing related to generation of transaction data or blocks in a blockchain.

For example, a constant may be preset in a genesis block of the blockchain, and the information processing method may include: obtaining the constant and generating the transaction data using, as T, the constant obtained.

According to this aspect, the information processing device can set the number of blocks connected downstream of the first block using the value of T set in the genesis block. The user can set the value of T more easily by storing the value of T in the genesis block. Thus, the information processing method according to the present disclosure can more easily contribute to reduction of power consumption required for processing related to generation of transaction data or blocks in a blockchain.

An information processing device according to an aspect of the present disclosure is an information processing device that, in a system including a plurality of information processing devices each holding a blockchain, is one information processing device out of the plurality of information processing devices, the information processing device including: a processor; and memory connected to the processor, wherein the processor, using the memory: generates a first block including one or more items of transaction data, and connects the first block to the blockchain; generates transaction data indicating payment of a reward for generating the first block, when at least T blocks are connected downstream of the first block in the blockchain where T is an integer greater than or equal to 1; and generates a second block including the transaction data generated, and connects the second block to the blockchain.

According to this aspect, the information processing device has the same effects as the foregoing information processing method.

A recording medium according to an aspect of the present disclosure is a non-transitory computer-readable recording medium having recorded thereon a program for causing a computer to execute the foregoing information processing method.

According to this aspect, the recording medium has the same effects as the foregoing information processing method.

These general and specific aspects may be implemented using a system, a device, an integrated circuit, a computer program, or a computer-readable recording medium such as CD-ROM, or any combination of a system, a device, an integrated circuit, a computer program, and a recording medium.

Hereinafter, certain exemplary embodiments will be described in greater detail with reference to the accompanying drawings.

Each of the exemplary embodiments described below shows a general or specific example. The numerical values, shapes, materials, elements, the arrangement and connection of the elements, steps, the processing order of the steps etc. illustrated in the following exemplary embodiments are mere examples, and therefore do not limit the scope of the appended claims and their equivalents. Therefore, among the elements in the following exemplary embodiments, those not recited in any one of the independent claims are described as optional elements.

### Embodiment

This embodiment will describe an information processing method, etc. that contribute to reduction of power consumption required for processing related to generation of transaction data or blocks in a blockchain.

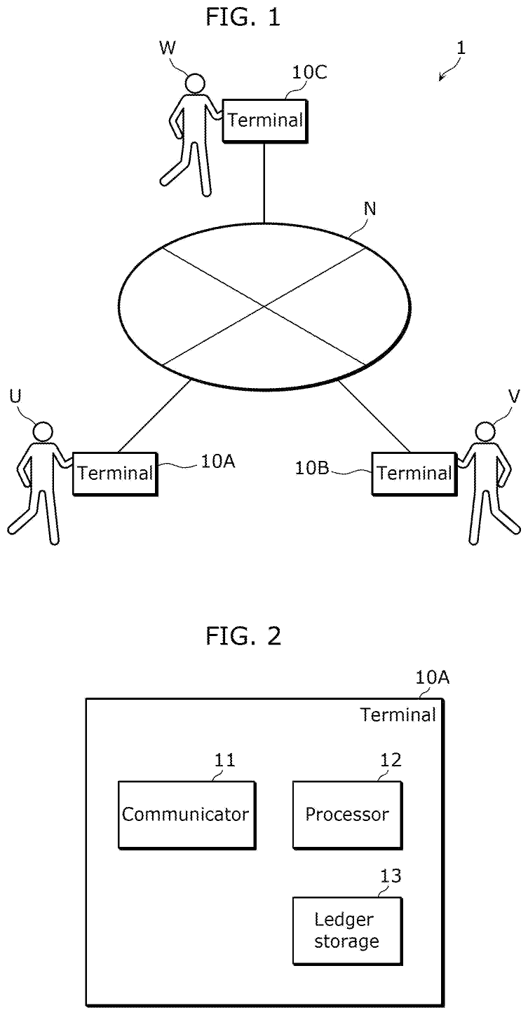

FIG. 1 is a block diagram schematically illustrating the structure of distributed ledger system 1 in this embodiment.

As illustrated in FIG. 1, distributed ledger system 1 includes terminals 10A, 10B, and 10C (also referred to as terminals 10A, etc.). Terminals 10A, etc. are each connected to network N, and can communicate with each other through network N.

Distributed ledger system 1 includes the plurality of terminals 10A, etc. that are a plurality of information processing devices each holding a blockchain which is a distributed ledger. Distributed ledger system 1 uses the blockchain to, for example, manage transfer history of value information (specifically, virtual currency, coupons, etc.) or information indicating ownership of electronic or physical content (also simply referred to as content), without being limited thereto.

Terminal 10A is one of the plurality of terminals 10A, etc. each holding the blockchain in distributed ledger system 1. The blockchain held in terminal 10A stores transaction data. The transaction data includes, for example, transfer history of value information or information indicating ownership of content, without being limited thereto. The user using terminal 10A is also referred to as user U.

Terminals 10B and 10C are each a device having the same functions as terminal 10A, and each operate independently of terminal 10A. The user using terminal 10B is also referred to as user V. The user using terminal 10C is also referred to as user W.

Although this embodiment describes an example in which distributed ledger system 1 includes three terminals 10A, etc., distributed ledger system 1 may include more terminals.

Network N may be any communication line or network. Examples include the Internet, a mobile phone carrier network, an Internet provider access network, and a public access network.

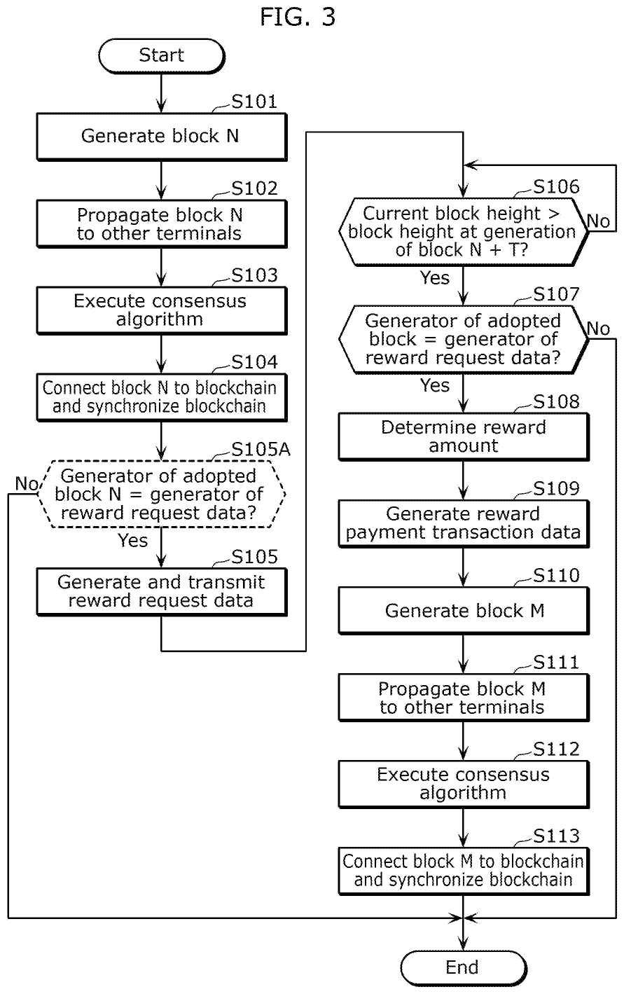

FIG. 2 is an explanatory diagram illustrating the functions of terminal 10A in this embodiment.

As illustrated in FIG. 2, terminal 10A includes communicator 11, processor 12, and ledger storage 13.

Communicator 11 is a communication interface communicably connected to network N. Communicator 11 includes a communication interface of a communication standard suitable for connection to network N. Communicator 11 may include a communication circuit for transmitting and receiving communication signals according to the communication standard, and a communication connector or a communication antenna.

Processor 12 is a functional unit that executes blockchain-related processing. Processor 12 can be implemented by a processor (for example, central processing unit (CPU)) (not illustrated) included in terminal 10A executing a program using memory (not illustrated).

Specifically, processor 12 generates a block (corresponding to a first block) including one or more items of transaction data to be stored in the blockchain, and connects the generated first block to the blockchain. The one or more items of transaction data to be stored in the blockchain may be transaction data stored in a transaction pool (not illustrated). The transaction pool is a storage area in a storage device (not illustrated) included in terminal 10A, in which transaction data to be stored in blocks is temporarily stored.

Processor 12 also transmits the generated first block to terminals 10B and 10C, and causes the first block to be connected to the blockchain held in each of terminals 10B and 10C. To connect a new block to the blockchain, a predetermined consensus algorithm is executed to form a consensus on the new block, and then the new block is connected to the blockchain. The consensus algorithm is a method of probabilistically establishing transactions, and examples thereof include Proof of Work (PoW) and Proof of Stake (PoS). In the case where a plurality of terminals 10A, etc. generate blocks substantially simultaneously, processor 12 adopts one block out of the generated plurality of first blocks and makes consensus formation.

In the case where the first block is connected to the blockchain, processor 12 also generates, when at least T blocks are connected downstream of the first block in the blockchain, transaction data (also referred to as reward payment transaction data) indicating payment of a reward for generating the first block. Processor 12 generates a block (corresponding to a second block) including the generated reward payment transaction data, and connects the generated second block to the blockchain.

Here, T is an integer greater than or equal to 1. When T is larger, reward payment transaction data is generated when more blocks are connected downstream of the first block, that is, the generation of reward payment transaction data is slower. When T is smaller, reward payment transaction data is generated when fewer blocks are connected downstream of the first block, that is, the generation of reward payment transaction data is faster. For example, T can be set to a numerical value (typically 6) that indicates how many blocks need to be connected after the connection of the first block to the blockchain for the first block to be treated as established. T may be set smaller in the case where the blockchain is a private chain than in the case where the blockchain is a public chain. In the case of a private chain, the probability of attacks intended to cause chain branching and discarding is relatively low, and accordingly speeding the generation of reward payment transaction data is effective in speeding reward payment. In the case of a public chain, the probability of attacks intended to cause chain branching and discarding is relatively high, and accordingly slowing the generation of reward payment transaction data is effective in further reducing processing and power that will end up being wasted.

Before generating the reward payment transaction data, processor 12 may determine whether a reward condition is satisfied, and generate the reward payment transaction data in the case where processor 12 determines that the reward condition is satisfied. The reward condition is a condition for paying the reward to terminal 10A. In the case where processor 12 determines that the reward condition is not satisfied, the reward payment transaction data is not generated (i.e. the generation of the reward payment transaction data is prohibited).

Storing the reward payment transaction data in the blockchain corresponds to paying the reward to terminal 10A or the like, for example, corresponds to adding value information equivalent to the reward to the balance of the account corresponding to terminal 10A or the like. Paying the reward to terminal 10A can mean paying the reward to user U who uses terminal 10A. The same applies to terminals 10B and 10C and users V and W.

More specifically, the reward condition includes at least the condition that both of the following conditions (a) and (b) are satisfied.

(a) The condition that a second value is greater than a first value by at least T, where the first value is the block height of the blockchain at the time of generating the first block, and the second value is the block height of the blockchain currently held in the device (also referred to as “first condition”).

(b) The condition that the generator of the first block adopted by the consensus algorithm and the generator of reward request data match (also referred to as “second condition”).

Herein, the reward request data is data requesting payment of reward for generating the first block, and is generated by the terminal that connects the first block to the blockchain. For example, in the case where terminal 10A connects the first block to the blockchain, terminal 10A generates the reward request data and, in response to the generation of the reward request data, performs the foregoing determination.

In the case where the first block is not connected to the blockchain at the time of determining whether condition (b) is satisfied (for example, in the case where the first block was not adopted by the consensus algorithm or in the case where, after the first block was connected to the chain, the chain including the first block was discarded by the time of the determination), it is determined that condition (b) is not satisfied.

The payment of the reward may be payment of a network token in the blockchain or payment of a utility token in the blockchain. The network token may be a token used to build and maintain the blockchain. The utility token may be a token used for a service that can be provided using the blockchain.

Processor 12 may obtain a constant preset in a genesis block of the blockchain and use the constant as T. The genesis block is the first block in the blockchain.

Processor 12 may determine, before the reward request data is generated, whether condition (b) is satisfied, and prohibit the generation of the reward request data in the case where processor 12 determines that condition (b) is not satisfied.

In conventional blockchain technology, when a terminal generates a block, the terminal includes, in the block, reward payment transaction data indicating payment of a reward for generating the block. In this embodiment, on the other hand, when processor 12 generates the first block, processor 12 includes, not in the first block but in the second block, reward payment transaction data indicating payment of a reward for generating the first block. In other words, the one or more items of transaction data included in the first block do not include transaction data indicating payment of a reward for generating the first block.

Ledger storage 13 is a storage that stores the blockchain, and is implemented by a storage device. The blockchain stored in ledger storage 13 stores one or more items of transaction data, and is managed using a feature such as hash values to make tampering difficult (described later). The blockchain stores the transaction data from the past to the present. Processor 12 connects a block to the blockchain stored in ledger storage 13.

Processes by terminal 10A having the above-described structure will be described below.

FIG. 3 is a flowchart illustrating processes by terminal 10A in this embodiment.

In Step S101, processor 12 generates block N. Specifically, processor 12 obtains one or more items of transaction data stored in the transaction pool in terminal 10A at the time of executing Step S101, and generates block N including the obtained one or more items of transaction data. “N” in “block N” is an identifier of the block.

In Step S102, processor 12 propagates block N generated in Step S101 to the other terminals, i.e. terminals 10B and 10C. Processor 12 propagates block N by transmitting block N to terminals 10B and 10C.

In Step S103, processor 12 executes a consensus algorithm to form a consensus with terminals 10B and 10C for block N propagated in Step S102. Here, if a terminal (i.e. terminal 10B or 10C) different from terminal 10A also generates and propagates block N, one block N out of block N generated by the other terminal and block N generated by terminal 10A is adopted.

In Step S104, processor 12 connects block N, for which the consensus has been formed in Step S103, to the blockchain, and synchronizes the blockchain with terminals 10B and 10C. Consequently, block N is connected to the blockchain in terminals 10B and 10C as well.

In Step S105, processor 12 generates reward request data, and transmits the generated reward request data to terminals 10B and 10C. The reward request data includes at least the identifier (i.e. N) indicating the block generated in Step S101.

In Step S106, processor 12 determines whether condition (a) is satisfied, that is, whether the following (Formula 1) holds. In the case where processor 12 determines that condition (a) is satisfied (i.e. (Formula 1) holds) (Step S106: Yes), processor 12 advances to Step S107. Otherwise (Step S106: No), processor 12 executes Step S106 again. That is, processor 12 waits until condition (a) is satisfied in Step S106.

The block height of the current blockchain (corresponding to the second value)>the block height of the blockchain at the time of execution of Step S101 (corresponding to the first value)+T (Formula 1).

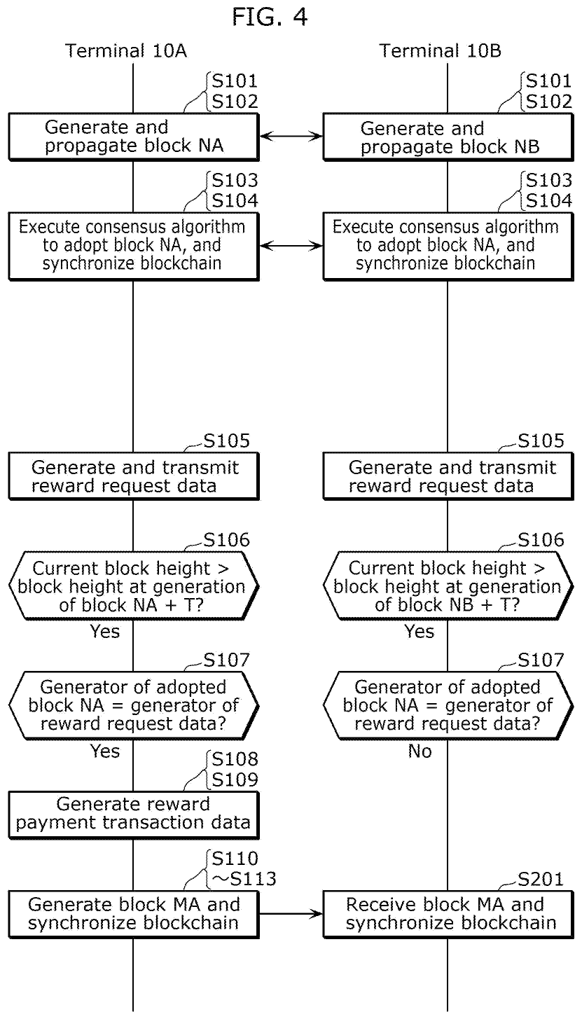

While waiting in Step S106, processor 12 may receive a block generated by another terminal and connect it to the blockchain by an execution unit different from the execution unit of the series of processes illustrated in FIG. 4. In such a case, the block height of the current blockchain may increase. If the block height of the current blockchain increases and as a result becomes greater than the block height of the blockchain at the time of execution of Step S101 by at least T, (Formula 1) holds. After (Formula 1) holds, processor 12 releases the wait state and advances to Step S107. An execution unit is a unit in which a computer executes processing, and corresponds to a process, thread, or task.

In Step S107, processor 12 determines whether condition (b) is satisfied, that is, whether the generator of block N generated in Step S101 matches the generator of the reward request data generated in Step S105. In the case where a plurality of blocks N are generated by a plurality of terminals 10A, etc. substantially simultaneously, the generator of block N is the generator of one block N adopted by the consensus algorithm. The same applies hereafter. In the case where the generator of block N matches the generator of the reward request data (Step S107: Yes), processor 12 advances to Step S108. Otherwise (Step S107: No), the series of processes illustrated in FIG. 3 ends.

In Step S108, processor 12 determines a reward amount. For example, the reward amount may include the total of the reward amounts set for the respective items of transaction data included in block N generated in Step S101. The reward amount may include, in addition to the foregoing reward amount, a reward amount predetermined as a reward amount for generating a block. Processor 12 may determine the reward amount by querying an external database.

In Step S109, processor 12 generates reward payment transaction data indicating payment of the reward of the reward amount determined in Step S108 as a reward for generating block N.

In Step S110, processor 12 generates block M. Block M includes at least the reward payment transaction data generated in Step S109. Block M may include other transaction data.

In Step S111, processor 12 propagates block M generated in Step S110 to the other terminals, i.e. terminals 10B and 10C. Processor 12 propagates block M by transmitting block M to terminals 10B and 10C.

In Step S112, processor 12 executes the consensus algorithm to form a consensus with terminals 10B and 10C for block M propagated in Step S111.

In Step S113, processor 12 connects block M generated in Step S110 to the blockchain, and synchronizes the blockchain with terminals 10B and 10C. Consequently, block M is connected to the blockchain in terminals 10B and 10C as well.

Before executing Step S105, processor 12 may determine condition (b) as in Step S107 (Step S105A). In this case, in Step S105A, if the generator of block N is the same as the generator of the reward request data (Step S105A: Yes), processor 12 advances to Step S105. Otherwise (Step S105A: No), the series of processes illustrated in FIG. 3 ends. Thus, in the case where condition (b) is not satisfied, terminal 10A avoids executing the processes in Steps S105 and S106. This has the effect of saving the time and power required for the processes in Steps S105 and S106.

The operation of distributed ledger system 1 in the case where a plurality of terminals 10A, etc. generate blocks substantially simultaneously will be described below.

FIG. 4 is a first sequence diagram illustrating processes by distributed ledger system 1 in this embodiment. The operation of distributed ledger system 1 in the case where the plurality of terminals 10A and 10B generate blocks substantially simultaneously will be described below, with reference to FIG. 4.

In FIG. 4, the description of terminal 10C is omitted. The same processes as those illustrated in FIG. 3 are given the same reference signs, and their detailed description is omitted. FIG. 4 illustrates an instance in which the process in Step S105A is not executed.

First, terminal 10A generates block NA and propagates it to terminal 10B (Steps S101 and S102). Substantially simultaneously with this, terminal 10B generates block NB and propagates it to terminal 10A (Steps S101 and S102).

Terminals 10A and 10B execute a consensus algorithm and adopt one of blocks NA and NB (Step S103). It is assumed here that terminals 10A and 10B adopt block NA. Terminals 10A and 10B then synchronize the blockchain (Step S104).

Terminal 10A generates reward request data and transmits it to terminal 10B (Step S105). The reward request data generated by terminal 10A is data requesting payment of a reward for generating block NA.

Terminal 10B generates reward request data and transmits it to terminal 10A (Step S105). The reward request data generated by terminal 10B is data requesting payment of a reward for generating block NB.

Respectively when the block height of the blockchain held in terminal 10A becomes greater than the block height at the time of generating block NA by at least T and when the block height of the blockchain held in terminal 10B becomes greater than the block height at the time of generating block NB by at least T (Step S106: Yes), terminals 10A and 10B determine whether the block generator and the generator of the reward request data match (Step S107). Since the block generator and the generator of the reward request data match as a result of the determination by terminal 10A, terminal 10A executes the processes in Steps S108 and S109. Meanwhile, since the block generator and the generator of the reward request data do not match as a result of the determination by terminal 10B, terminal 10B does not execute the processes in Steps S108 and S109 (i.e. terminal 10B is prohibited from executing the processes).

After this, terminals 10A and 10B synchronize the blockchain to which block MA including reward payment transaction data generated by terminal 10A is connected (Steps S110 to S113, and S201).

As a result of the series of processes illustrated in FIG. 4, terminal 10B can avoid executing the process related to reward payment transaction data (Steps S108 and S109). This contributes to reduction of power consumption required for processing related to generation of transaction data or blocks.

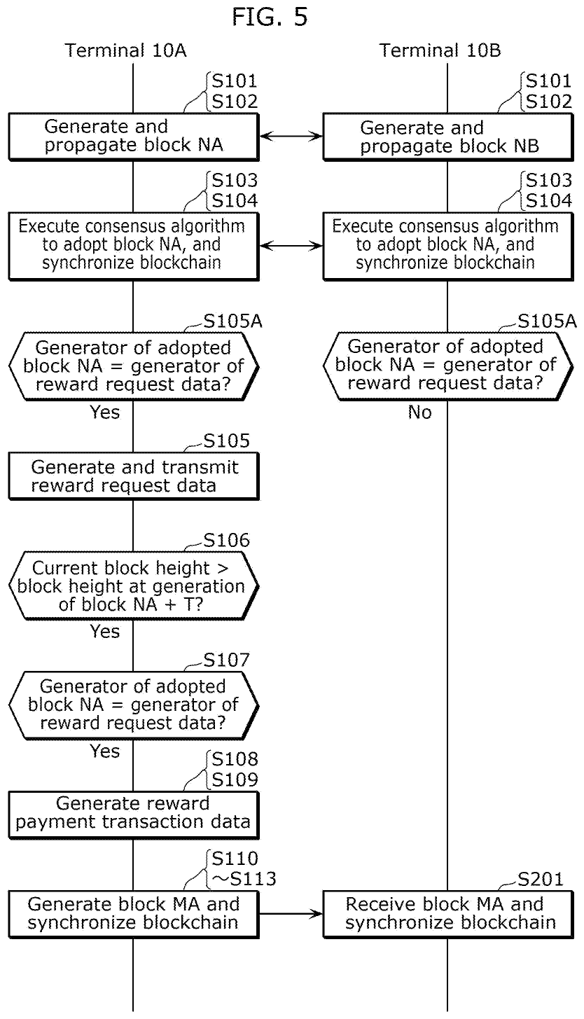

FIG. 5 is a second sequence diagram illustrating processes by distributed ledger system 1 in this embodiment. An example in which the plurality of terminals 10A and 10B generate blocks substantially simultaneously will be described below, with reference to FIG. 5.

In FIG. 5, the description of terminal 10C is omitted as in FIG. 4. The same processes as those illustrated in FIG. 3 or 4 are given the same reference signs, and their detailed description is omitted. FIG. 5 illustrates an instance in which the process in Step S105A is executed.

The generation and propagation of block NA by terminal 10A, the generation and propagation of block NB by terminal 10B, the execution of the consensus algorithm, and the synchronization of the blockchain are the same as those in FIG. 4 (Step S101 to 104).

After this, terminals 10A and 10B each determine whether the block generator and the generator of the reward request data match (Step S105A). Since the block generator and the generator of the reward request data match as a result of the determination by terminal 10A, terminal 10A executes the processes in Steps S105 to S109. Meanwhile, since the block generator and the generator of the reward request data do not match as a result of the determination by terminal 10B, terminal 10B does not execute the processes in Steps S105 to S109 (i.e. terminal 10B is prohibited from executing the processes).

After this, terminals 10A and 10B synchronize the blockchain to which block MA including reward payment transaction data generated by terminal 10A is connected (Steps S110 to S113, and S201).

As a result of the series of processes illustrated in FIG. 5, terminal 10B can avoid executing the process related to reward request data (Step S105), the reward condition determination process (Step S106 and 107), and the process related to reward payment transaction data (Steps S108 and S109). This contributes to reduction of power consumption required for processing related to generation of transaction data or blocks.

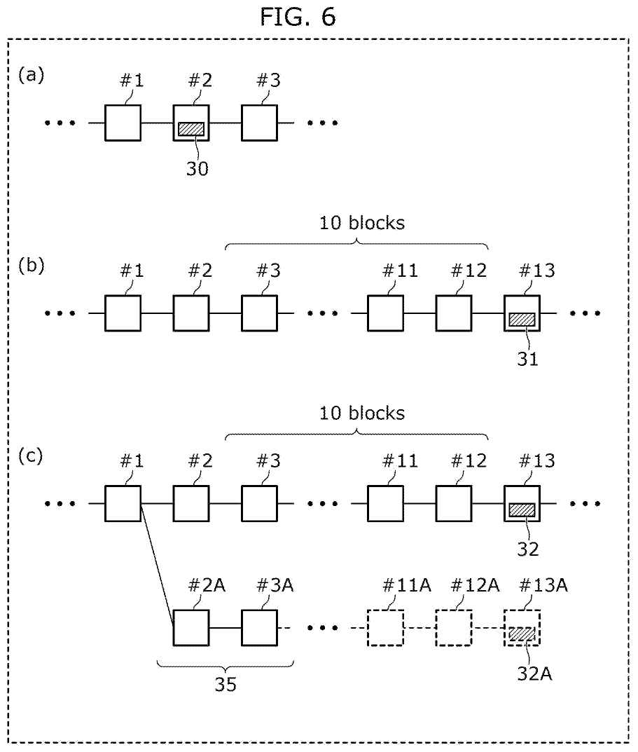

FIG. 6 is an explanatory diagram illustrating reward transaction data included in a blockchain generated by a terminal in this embodiment. For comparison with this embodiment, FIG. 6 also illustrates reward transaction data included in a blockchain generated by a terminal in a comparative example. The comparative example is a technology (conventional blockchain technology) in which, in the case where a terminal generates a block, reward payment transaction data indicating payment of a reward for generating the block is included in the block.
(a) in FIG. 6 illustrates reward payment transaction data 30 included in a blockchain generated by a terminal in the comparative example. Reward payment transaction data 30 is transaction data indicating payment of a reward for generating block #2, and is included in block #2.
(b) in FIG. 6 illustrates reward payment transaction data 31 included in a blockchain generated by a terminal in this embodiment. For example, suppose T is 10. Reward payment transaction data 31 is transaction data indicating payment of a reward for generating block #2. Reward payment transaction data 31 is not included in block #2, but included in block #13 generated after 10 blocks are connected downstream of block #2 in the blockchain.
(c) in FIG. 6 illustrates reward payment transaction data 32 included in a blockchain generated by a terminal in this embodiment in the case where chain branching occurs. Reward payment transaction data 32 is transaction data indicating payment of a reward for generating block #2, as with reward payment transaction data 31 in (b) in FIG. 6.

Chain 35 beyond the branch point (i.e. the chain including blocks #2A and #3A) is a chain that will be discarded because no new block has been connected following block #3A. With the technology according to the comparative example, reward payment transaction data indicating payment of a reward for generating block #2A is included in block #2A. The terminal in this embodiment, however, does not include the reward payment transaction data in block #2A. If chain 35 is not discarded, reward payment transaction data 32A indicating payment of a reward for generating block #2A included in chain 35 is included in block #13A downstream of block #3A. If chain 35 is discarded, reward payment transaction data 32A is not generated.

In this way, it is possible to avoid generating reward payment transaction data indicating payment of a reward for generating a block included in a chain that is discarded as a result of chain branching.

### Variation 1 of Embodiment

Regarding an information processing method, etc. that contribute to reduction of power consumption required for processing related to generation of transaction data or blocks in a blockchain, a variation of the embodiment will be described below. Specifically, a mode in which the reward condition determination process is executed by a smart contract will be described below.

The structure of distributed ledger system 1 in this variation is the same as that in the foregoing embodiment (see FIG. 1).

A terminal in this variation is referred to as terminal 10D to distinguish it from terminal 10A in the foregoing embodiment.

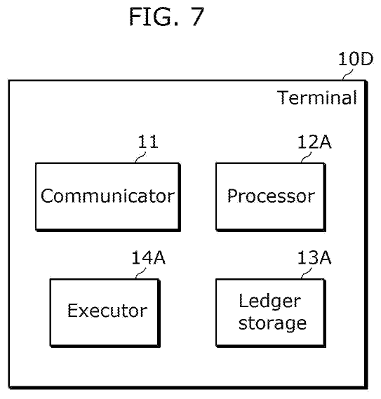

FIG. 7 is an explanatory diagram illustrating the functions of terminal 10D in the variation of the embodiment.

As illustrated in FIG. 7, terminal 10D includes communicator 11, processor 12A, ledger storage 13A, and executor 14A. Communicator 11 is the same as the component with the same name in the foregoing embodiment, and accordingly its description is omitted.

Processor 12A is a functional unit that executes blockchain-related processing, as with processor 12 in the foregoing embodiment. Processor 12A differs from processor 12 in that it generates transaction data (also referred to as reward request transaction data) as reward request data in the foregoing embodiment.

After generating a block to be stored in the blockchain, processor 12A generates reward request transaction data and connects a block including the reward request transaction data to the blockchain. Processor 12A synchronizes the blockchain with the other terminals. The reward request transaction data includes instruction information instructing to execute a reward payment smart contract. The reward payment smart contract is a smart contract that performs processes such as determining whether a reward condition is satisfied, determining a reward amount, and generating reward payment transaction data.

Ledger storage 13A is a storage that stores the blockchain, as with ledger storage 13 in the foregoing embodiment. The blockchain stored in ledger storage 13A includes not only the information included in the blockchain stored in ledger storage 13 but also the contract code of the reward payment smart contract.

Executor 14A is a functional unit that executes smart contracts. Executor 14A can be implemented by a processor (for example, central processing unit (CPU)) included in terminal 10D executing a program using memory.

Specifically, in response to processor 12A storing the transaction data including the instruction information instructing to execute the reward payment smart contract in the blockchain, executor 14A reads the contract code of the reward payment smart contract from ledger storage 13A and executes the reward payment smart contract.

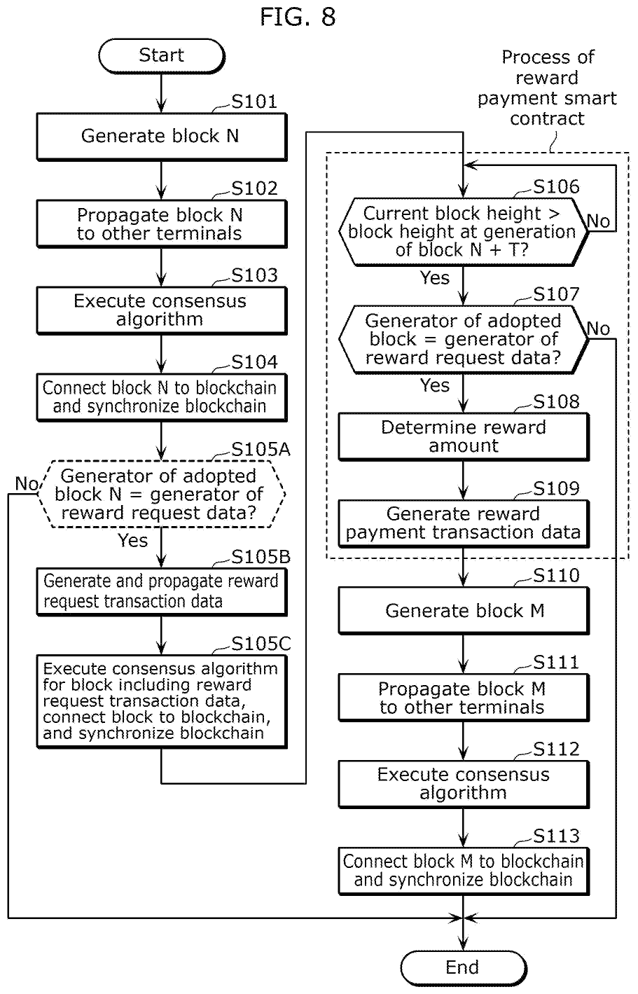

FIG. 8 is a flowchart illustrating processes by terminal 10D in the variation of the embodiment.

Of the processes illustrated in FIG. 8, the same processes as those by terminal 10A in the foregoing embodiment (see FIG. 3) are given the same reference signs, and their detailed description is omitted.

Steps S101 to S105A are the same as those by terminal 10A in the foregoing embodiment (see FIG. 3).

In Step S105B, processor 12A generates reward request transaction data, and propagates the reward request transaction data by transmitting it to the other terminals.

In Step S105C, processor 12A generates a block including the reward request transaction data generated in Step S105B, and executes a consensus algorithm for the generated block to form a consensus with the other terminals. After the consensus is formed, processor 12A connects the block to the blockchain and synchronizes the blockchain with the other terminals. As a result, executor 14A executes the reward payment smart contract. The processes in Steps S106 to S109 are executed by executing the reward payment smart contract.

In this way, terminal 10D contributes to reduction of power consumption required for processing related to generation of transaction data or blocks in a blockchain.

### Variation 2 of Embodiment

Regarding an information processing method, etc. that contribute to reduction of power consumption required for processing related to generation of transaction data or blocks in a blockchain, a variation of the embodiment will be described below.

The structure of distributed ledger system 1 in this variation is the same as that in the foregoing embodiment (see FIG. 1).

Processes by a terminal in this variation will be described below.

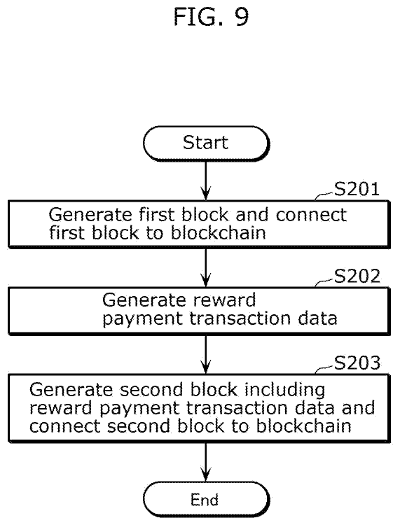

FIG. 9 is a flowchart illustrating processes by the terminal in this variation.

In Step S201, the terminal generates a first block including one or more items of transaction data, and connects the first block to the blockchain. Step S201 corresponds to at least Steps S101 to S104 in the foregoing embodiment.

In Step S202, the terminal generates transaction data indicating payment of a reward for generating the first block, when at least T blocks (T is an integer equal to or greater than 1) are connected downstream of the first block in the blockchain. Step S202 corresponds to at least Step S109 in the foregoing embodiment.

In Step S203, the terminal generates a second block including the transaction data generated in Step S202, and connects the second block to the blockchain. Step S203 corresponds to at least Steps S110 to S113 in the foregoing embodiment.

In this way, the terminal contributes to reduction of power consumption required for processing related to generation of transaction data or blocks in a blockchain.

### Supplemental Remarks

The distributed ledger in the foregoing embodiment or variations will be described below. While a blockchain is described as an example of the distributed ledger here, the same applies to other distributed ledgers.

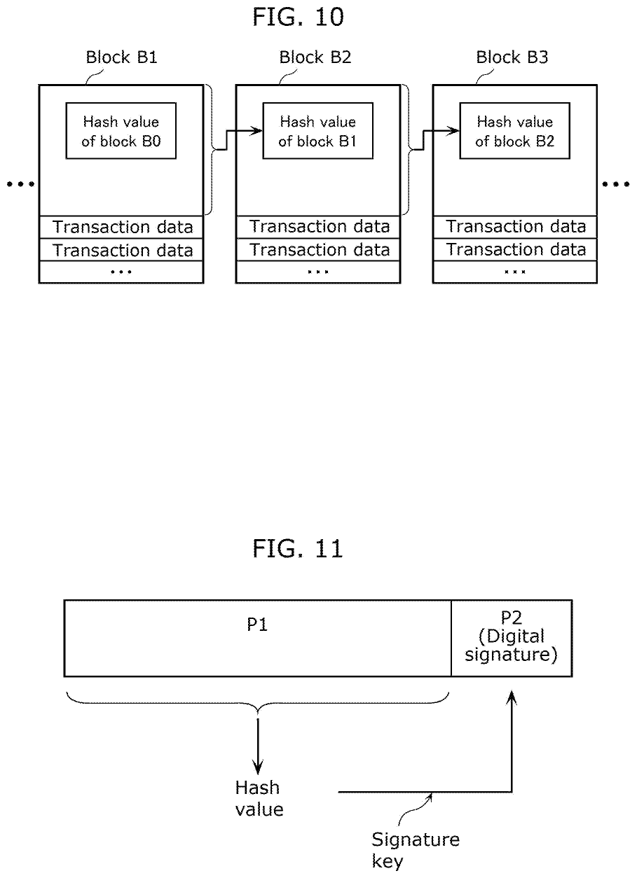

FIG. 10 is an explanatory diagram illustrating the data structure of a blockchain.

The blockchain is formed by connecting blocks as recording units in a chain. Each block has a plurality of items of transaction data and a hash value of the immediately previous block. Specifically, block B2 includes a hash value of block B1 preceding block B2. A hash value calculated from a plurality of items of transaction data and the hash value of block B1 included in block B2 is included in block B3 as a hash value of block B2. By connecting blocks in a chain where each block includes information of the previous block as a hash value in this way, tampering with recorded transaction data can be effectively prevented.

If past transaction data is changed, the hash value of the block will end up being different from the value before the change. To disguise the tampered block as proper, all subsequent blocks need to be recreated. Such operation is practically very difficult. This property is used to ensure the difficulty of tampering with blockchains.

FIG. 11 is an explanatory diagram illustrating the data structure of transaction data.

The transaction data illustrated in FIG. 11 includes transaction body P1 and digital signature P2. Transaction body P1 is a data body included in the transaction data. Digital signature P2 is generated by signing a hash value of transaction body P1 using a signature key of the generator of the transaction data, i.e. by encrypting the hash value using a private key of the generator.

Since the transaction data includes digital signature P2, tampering is substantially impossible. Tampering with the transaction body is thus prevented.

As described above, with the information processing method according to any of the foregoing embodiment and variations, the information processing device includes, in the second block connected downstream of the first block, the transaction data (also referred to as reward payment transaction data) indicating payment of a reward for generating the first block. This may make it possible to prevent generation of reward payment transaction data for the first block in the case where the first block is discarded after the generation of the first block. In such a case, power consumption required for processing related to the generation of the reward payment transaction data can be reduced. Thus, the information processing method according to the present disclosure can contribute to reduction of power consumption required for processing related to generation of transaction data or blocks in a blockchain.

Moreover, the information processing device performs determination using the reward condition, and therefore can easily determine whether to generate reward payment transaction data for the first block. Thus, the information processing method according to the present disclosure can more easily contribute to reduction of power consumption required for processing related to generation of transaction data or blocks in a blockchain.

Moreover, the information processing device more easily determines whether the reward condition is satisfied, using the condition regarding the block height of the blockchain and the condition regarding matching between the generator of the block and the generator of the reward request data. Thus, the information processing method according to the present disclosure can more easily contribute to reduction of power consumption required for processing related to generation of transaction data or blocks in a blockchain.

Moreover, the information processing device determines the condition regarding matching between the generator of the block and the generator of the reward request data before the reward request data is generated. It is therefore possible to avoid the generation of the reward request data in the case where the generator of the block and the generator of the reward request data do not match. In such a case, power consumption required for processing related to the generation of the reward request data can be further reduced. Thus, the information processing method according to the present disclosure can contribute to further reduction of power consumption required for processing related to generation of transaction data or blocks in a blockchain.

Moreover, the information processing device does not include, in the first block, the transaction data (also referred to as reward payment transaction data) indicating payment of a reward for generating the first block. This may make it possible to prevent generation of reward payment transaction data for the first block in the case where the first block is discarded after the generation of the first block. Thus, the information processing method according to the present disclosure can contribute to reduction of power consumption required for processing related to generation of transaction data or blocks in a blockchain.

Moreover, the information processing device uses a relatively small value as T in the case where the blockchain is a private chain. This has the effect of speeding the payment of the reward by speeding the generation of the reward payment transaction data. Meanwhile, the information processing device uses a relatively large value as T in the case where the blockchain is a public chain. This has the effect of further reducing processing and power that will end up being wasted by slowing the generation of the reward payment transaction data. Hence, the information processing device can adjust the effect of speeding reward payment and the effect of further reducing power depending on whether the blockchain is a private chain or a public chain. Thus, the information processing method according to the present disclosure can contribute to reduction of power consumption required for processing related to generation of transaction data or blocks in a blockchain while speeding payment of reward for block generation.

Moreover, the information processing device executes the process of determining whether the reward condition is satisfied by the smart contract. The process is therefore appropriately and automatically executed without tampering upon the generation of the transaction data as the reward request data. Thus, the information processing method according to the present disclosure can more appropriately contribute to reduction of power consumption required for processing related to generation of transaction data or blocks in a blockchain.

Moreover, the information processing device uses payment of network tokens or utility tokens in the blockchain to enable easier payment of the reward for generating the first block, with it being possible to reduce power consumption. Thus, the information processing method according to the present disclosure can more easily contribute to reduction of power consumption required for processing related to generation of transaction data or blocks in a blockchain.

Moreover, the information processing device can set the number of blocks connected downstream of the first block using the value of T set in the genesis block. The user can set the value of T more easily by storing the value of T in the genesis block. Thus, the information processing method according to the present disclosure can more easily contribute to reduction of power consumption required for processing related to generation of transaction data or blocks in a blockchain.

Each of the structural elements in the foregoing embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or semiconductor memory. For example, software for realizing the content management system, etc. according to the foregoing embodiment is the following program.

The program causes a computer to execute an information processing method that, in a system including a plurality of information processing devices each holding a blockchain, is executed by one information processing device out of the plurality of information processing devices, the information processing method including: generating a first block including one or more items of transaction data, and connecting the first block to the blockchain; generating transaction data indicating payment of a reward for generating the first block, when at least T blocks are connected downstream of the first block in the blockchain where T is an integer greater than or equal to 1; and generating a second block including the transaction data generated, and connecting the second block to the blockchain.

While an information processing method, etc. according to one or more aspects have been described above by way of embodiments, the present disclosure is not limited to such embodiments. Other modifications obtained by applying various changes conceivable by a person skilled in the art to the embodiments and any combinations of the structural elements in different embodiments without departing from the scope of the present disclosure are also included in the scope of one or more aspects.

### INDUSTRIAL APPLICABILITY

The present disclosure can be used in distributed ledger systems that manage distributed ledgers.

1. An information processing method that, in a system including a plurality of information processing devices each holding a blockchain, is executed by one information processing device out of the plurality of information processing devices, the information processing method comprising:
generating a first block including one or more items of transaction data, and connecting the first block to the blockchain;
generating transaction data indicating payment of a reward for generating the first block, when at least T blocks are connected downstream of the first block in the blockchain where T is an integer greater than or equal to 1; and
generating a second block including the transaction data generated, and connecting the second block to the blockchain.

2. The information processing method according to claim 1,
wherein the generating of the transaction data includes:
determining whether a reward condition for paying the reward to the one information processing device is satisfied; and
generating the transaction data when the reward condition is determined to be satisfied.

3. The information processing method according to claim 2, comprising:
generating reward request data requesting the payment of the reward, when the first block is connected to the blockchain,
wherein the determining is performed in response to the reward request data being generated, and
the reward condition includes a condition that both of the following are satisfied:
(a) a first condition that a second value is greater than a first value by at least T, where the first value is a block height of the blockchain at a time of generating the first block, and the second value is a block height of the blockchain currently held in the one information processing device; and
(b) a second condition that a generator of the first block and a generator of the reward request data match.

4. The information processing method according to claim 3, further comprising:
determining whether the second condition is satisfied, before the generating of the reward request data; and
prohibiting the generating of the reward request data, when the second condition is determined to be not satisfied.

5. The information processing method according to claim 1,
wherein the first block does not include the transaction data indicating the payment of the reward for generating the first block.

6. The information processing method according to claim 1,
wherein T is smaller when the blockchain is a private chain than when the blockchain is a public chain.

7. The information processing method according to claim 3,
wherein the determining of whether the reward condition is satisfied is executed by a smart contract, and
the reward request data is transaction data including instruction information instructing to execute the smart contract.

8. The information processing method according to claim 1,
wherein the payment of the reward includes payment of a network token in the blockchain or payment of a utility token in the blockchain.

9. The information processing method according to claim 1,
wherein a constant is preset in a genesis block of the blockchain, and
the information processing method comprises:
obtaining the constant and generating the transaction data using, as T, the constant obtained.

10. An information processing device that, in a system including a plurality of information processing devices each holding a blockchain, is one information processing device out of the plurality of information processing devices, the information processing device comprising:
a processor; and
memory connected to the processor,
wherein the processor, using the memory:
generates a first block including one or more items of transaction data, and connects the first block to the blockchain;
generates transaction data indicating payment of a reward for generating the first block, when at least T blocks are connected downstream of the first block in the blockchain where T is an integer greater than or equal to 1; and
generates a second block including the transaction data generated, and connects the second block to the blockchain.

11. A non-transitory computer-readable recording medium having recorded thereon a program for causing a computer to execute the information processing method according to claim 1.
